(19) United States
(12) Patent Application Publication
(10) Pub. No.: US 2019/0268526 A1
(43) Pub. Date: Aug. 29, 2019

(54) UN-MUTING AUDIO BASED ON PAN DEVICE STATE

(71) Applicant: MOTOROLA SOLUTIONS, INC, Chicago, IL (US)

(72) Inventors: ALEXANDER SOSNOVSKY, NETANYA (IL); OLESYA EVSTRATOVA, PETACH-TIKVA (IL); JACOB SHEM TOV, JERUSALEM (IL)

(21) Appl. No.: 15/907,382

(22) Filed: Feb. 28, 2018

(51) Int. Cl. H04N 5/232; G06F 3/16; H04N 5/225; H04N 7/18

(52) U.S. Cl. CPC H04N 5/23203; H04N 7/185; H04N 5/2253; G06F 3/165

(57) ABSTRACT

A method and apparatus for muting and unmuting audio is provided herein. During operation a dispatch center will have knowledge of a state of devices used to form an officer's personal-area network (PAN). Audio streamed from the officer may be unmuted based on a device state for any device within the PAN.

### BACKGROUND OF THE INVENTION

With body-worn cameras becoming ubiquitous, public-safety officers sharing video will become more-and-more common. When multiple officers simultaneously share video from their body-worn cameras, a dispatch center may have multiple video streams from multiple officers streaming simultaneously. When viewing multiple streamed videos simultaneously (for example on multiple screens at a dispatch center), dispatch operators often mute the audio on the multiple videos to prevent confusion. Muting of the videos often leads to critical content being missed. Therefore, a need exists for a method and apparatus for un-muting audio so that critical content is not missed by the officer.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates an operational environment for the present invention.

FIG. 2 depicts an example communication system that incorporates a personal-area network and a digital assistant.

FIG. 3 is a more-detailed view of a personal-area network of FIG. 2.

FIG. 4 is a block diagram of a dispatch center.

FIG. 5 is a block diagram of a hub.

FIG. 6 is a flow chart showing operation of the dispatch center of FIG. 4.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for unmuting audio is provided herein. During operation a dispatch center will have knowledge of a state of devices/sensors used to form an officer's personal-area network (PAN). Audio streamed from the officer may be unmuted based on a device state for any device within the PAN.

For example, consider a situation where multiple videos are being streamed to a dispatch center simultaneously. Some (if not all) video streams are muted. When a gun-draw is detected by a PAN sensor worn by the officer, video streamed by that officer will be unmuted. If any other video stream is currently un-muted, that video stream may be muted.

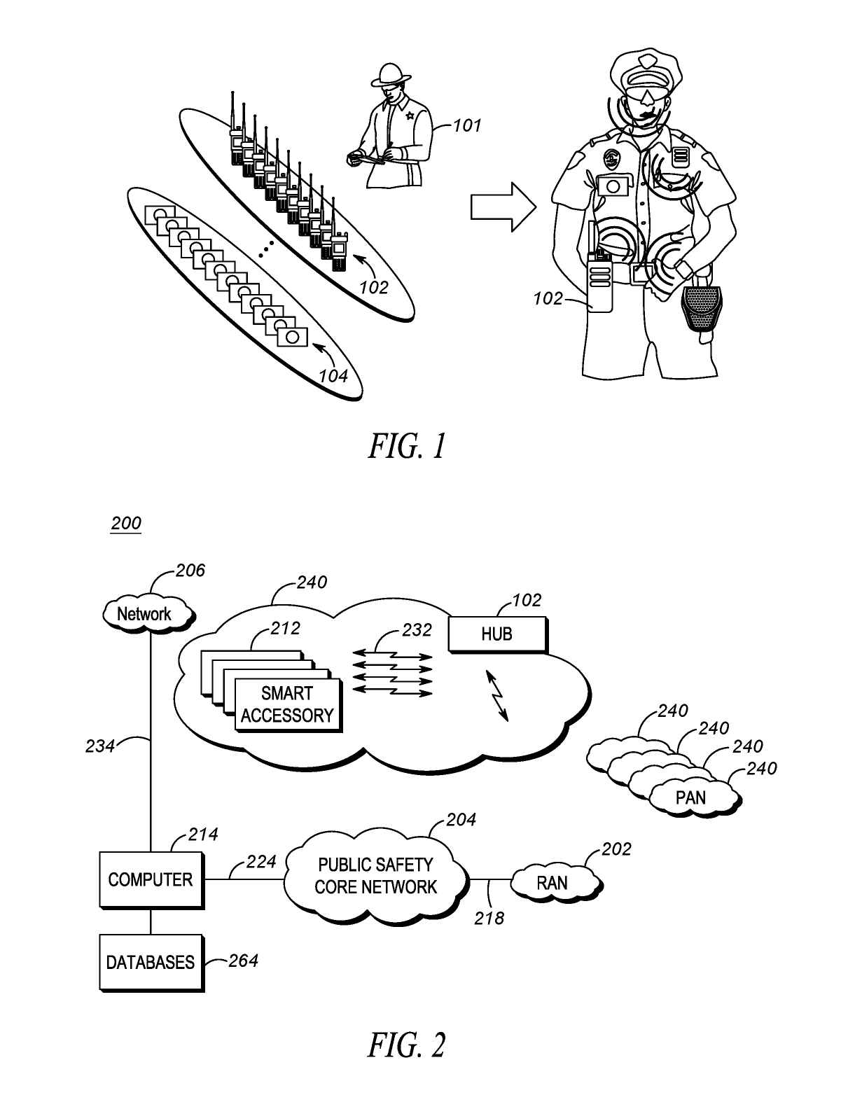

Turning now to the drawings, wherein like numerals designate like components, FIG. 1 illustrates an operational environment for the present invention. As shown, a public safety officer 101 will be equipped with devices that determine various physical and environmental conditions surrounding the public-safety officer. These conditions are generally reported back to a dispatch center so an appropriate action may be taken. For example, police officers may have a sensor that determines when a gun is drawn. Upon detecting that an officer has drawn their gun, a notification may be sent back to the dispatch operator so that, for example, the dispatch operator may be made aware of the situation and other officers in the area may be notified.

It is envisioned that the public-safety officer will have an array of shelved devices available to the officer at the beginning of a shift. The officer will select the devices off the shelf, and form a personal area network (PAN) with the devices that will accompany the officer on his shift. For example, the officer may pull a gun-draw sensor, a body-worn camera, a wireless microphone, a smart watch, a police radio, smart handcuffs, a man-down sensor, . . . , etc. All devices pulled by the officer will be configured to form a PAN by associating (pairing) with each other and communicating wirelessly among the devices. In a preferred embodiment, the PAN comprises more than two devices, so that many devices are connected via the PAN simultaneously.

A method called bonding is typically used for recognizing specific devices and thus enabling control over which devices are allowed to connect to each other when forming the PAN. Once bonded, devices then can establish a connection without user intervention. A bond is created through a process called “pairing”. The pairing process is typically triggered by a specific request by the user to create a bond from a user via a user interface on the device.

As shown in FIG. 1, public-safety officer 101 has an array of devices to use during the officer's shift. For example, the officer may pull one radio 102 and one camera 104 for use during their shift. Other devices may be pulled as well. As shown in FIG. 1, officer 101 will preferably wear the devices during a shift by attaching the devices to clothing. These devices will form a PAN throughout the officer's shift.

FIG. 2 depicts an example communication system 200 that incorporates PANs created as described above. System 200 includes one or more radio access networks (RANs) 202, a public-safety core network 204, high-speed data network 206, hub (PAN master device) 102, local devices (slave devices that serve as smart accessories/sensors) 212, computer 214, and communication links 218, 224, 232, and 234. In a preferred embodiment of the present invention, hub 102 and devices 212 form PAN 240, with communication links 232 between devices 212 and hub 102 taking place utilizing a short-range communication system protocol such as a Bluetooth communication system protocol. Each officer will have an associated PAN 240. Thus, FIG. 2 illustrates multiple PANs 240 associated with multiple officers.

RAN 202 includes typical RAN elements such as base stations, base station controllers (BSCs), routers, switches, and the like, arranged, connected, and programmed to provide wireless service to user equipment (e.g., hub 102, and the like) in a manner known to those of skill in the relevant art. RAN 202 may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards.

High-speed data network 206 is provided. Network 206 may comprise a Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VoIP), an LTE Direct or LTE Device to Device, or a PTT over IP (PoIP) application may be implemented. In still further embodiments, network 206 may implement a Wi-Fi protocol perhaps in accordance with an IEEE 802.11 standard (e.g., 802.11a, 802.11b, 802.11g) or a WiMAX protocol perhaps operating in accordance with an IEEE 802.16 standard.

Video and sensor 212 data shared among officers is typically (but not necessarily) accomplished by utilizing network 206, capable of achieving large data rates, while voice communications take place through network 204. Thus, voice communications among public-safety officers typically take place through one network, while video shared among typically take place through another network.

Public-safety core network 204 may include one or more packet-switched networks and/or one or more circuit-switched networks, and in general provides one or more public-safety agencies with any necessary computing and communication needs, transmitting any necessary public-safety-related data and communications.

For narrowband LMR wireless systems, core network 204 operates in either a conventional or trunked configuration. In either configuration, a plurality of communication devices is partitioned into separate groups (talkgroups) of communication devices. In a conventional narrowband system, each communication device in a group is selected to a particular radio channel (frequency or frequency & time slot) for communications associated with that communication device's group. Thus, each group is served by one channel, and multiple groups may share the same single frequency (in which case, in some embodiments, group IDs may be present in the group data to distinguish between groups using the same shared frequency).

In contrast, a trunked radio system and its communication devices use a pool of traffic channels for virtually an unlimited number of groups of communication devices (e.g., talkgroups). Thus, all groups are served by all channels. The trunked radio system works to take advantage of the probability that not all groups need a traffic channel for communication at the same time.

Group calls may be made between wireless and/or wireline participants in accordance with either a narrowband or a broadband protocol or standard. Group members for group calls may be statically or dynamically defined. That is, in a first example, a user or administrator may indicate to the switching and/or radio network (perhaps at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., communication devices) could be provisioned in the network by the user or an agent, and then provided some form of group identity or identifier, for example. Then, at a future time, an originating user in a group may cause some signaling to be transmitted indicating that he or she wishes to establish a communication session (e.g., join a group call having a particular talkgroup ID) with each of the pre-designated participants in the defined group. In another example, communication devices may dynamically affiliate with a group (and also disassociate with the group) perhaps based on user input, and the switching and/or radio network may track group membership and route new group calls according to the current group membership.

Hub 102 serves as a PAN master device, and may be any suitable computing and communication device configured to engage in wireless communication with the RAN 202 over the air interface as is known to those in the relevant art. Moreover, one or more hubs 102 are further configured to engage in wired and/or wireless communication with one or more local device 212 via the communication link 232. Hub 102 will be configured to determine when to forward information received from PAN devices 212 to, for example, dispatch center 214. The information can be forwarded to the dispatch center via RANs 202 and/or network 206 based on a combination of device 212 inputs. In one embodiment, all information received from sensors 212 will be forwarded to center 214 via RAN 202 or network 206. In another embodiment, hub 102 will filter the information sent, and only send high-priority information back to dispatch center 214.

It should also be noted that any one or more of the communication links 218, 224, 234 could include one or more wireless-communication links and/or one or more wired-communication links.

Devices 212 and hub 102 may comprise any device capable of forming a PAN. For example, devices 212 may comprise a gun-draw sensor, a body temperature sensor, an accelerometer, a heart-rate sensor, a breathing-rate sensor, a camera, a man-down sensor, a GPS receiver capable of determining a location, speed, and direction of the user device, smart handcuffs, a clock, calendar, environmental sensors (e.g. a thermometer capable of determining an ambient temperature, humidity, presence of dispersed chemicals, radiation detector, etc.), an accelerometer, a biometric sensor (e.g., wristband), a barometer, speech recognition circuitry, a gunshot detector, . . . , etc. Some examples follow:

A sensor-enabled holster 212 may be provided that maintains and/or provides state information regarding a weapon or other item normally disposed within the user's sensor-enabled holster 212. The sensor-enabled holster 212 may detect a change in state (presence to absence) and/or an action (removal) relative to the weapon normally disposed within the sensor-enabled holster 212. The detected change in state and/or action may be reported to the portable radio 102 via its short-range transceiver. In some embodiments, the sensor-enabled holster may also detect whether the first responder's hand is resting on the weapon even if it has not yet been removed from the holster and provide such information to portable radio 102. Other possibilities exist as well.

A biometric sensor 212 (e.g., a biometric wristband) may be provided for tracking an activity of the user or a health status of the user 101, and may include one or more movement sensors (such as an accelerometer, magnetometer, and/or gyroscope) that may periodically or intermittently provide to the portable radio 102 indications of orientation, direction, steps, acceleration, and/or speed, and indications of health such as one or more of a captured heart rate, a captured breathing rate, and a captured body temperature of the user 101, perhaps accompanying other information.

An accelerometer 212 may be provided to measures acceleration. Single and multi-axis models are available to detect magnitude and direction of the acceleration as a vector quantity, and may be used to sense orientation, acceleration, vibration shock, and falling. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction in which a person or device is facing.

A heart rate sensor 212 may be provided and use electrical contacts with the skin to monitor an electrocardiography (EKG) signal of its wearer, or may use infrared light and imaging device to optically detect a pulse rate of its wearer, among other possibilities.

A breathing rate sensor 212 may be provided to monitor breathing rate. The breathing rate sensor may include use of a differential capacitive circuits or capacitive transducers to measure chest displacement and thus breathing rates. In other embodiments, a breathing sensor may monitor a periodicity of mouth and/or nose-exhaled air (e.g., using a humidity sensor, temperature sensor, capnometer or spirometer) to detect a respiration rate. Other possibilities exist as well.

A body temperature sensor 212 may be provided, and includes an electronic digital or analog sensor that measures a skin temperature using, for example, a negative temperature coefficient (NTC) thermistor or a resistive temperature detector (RTD), may include an infrared thermal scanner module, and/or may include an ingestible temperature sensor that transmits an internally measured body temperature via a short range wireless connection, among other possibilities. Temperature sensor 212 may be used on equipment to determine if the equipment is being worn or not. For example, temperature sensor 212 may exist interior to a bullet-proof vest. I the temperature sensor 212 senses a temperature above a predetermined threshold (e.g., 80 degrees), it may be assumed that the vest is being worn by an officer.

Computer 214 comprises, or is part of a computer-aided-dispatch center, manned by an operator providing necessary dispatch operations. For example, computer 214 typically comprises a graphical user interface that provides the dispatch operator necessary information about public-safety officers. As discussed above, much of this information originates from devices 212 providing information to hub 102, which forwards the information to RAN 202/network 206 and ultimately to computer 214. Computer 214 is thus configured to receive sensor data from sensors 212 and keep track of relevant information. For example, each user of the system may possess a hub with many associated devices forming a PAN. For each user of the system, computer 214 may track the user's current associated PAN devices (sensors 212) along with sensor data for that user. This information may be used to compile a summary for each user (e.g., equipment on hand for each user, along with state information for the equipment (gun drawn, battery low, heart rate high, . . . , etc.)). The information is preferably stored in database 264.

With the above in mind, computer 214 is also configured with at least one video screen and speakers (not shown in FIG. 2) to stream at least one video from an officer's camera.

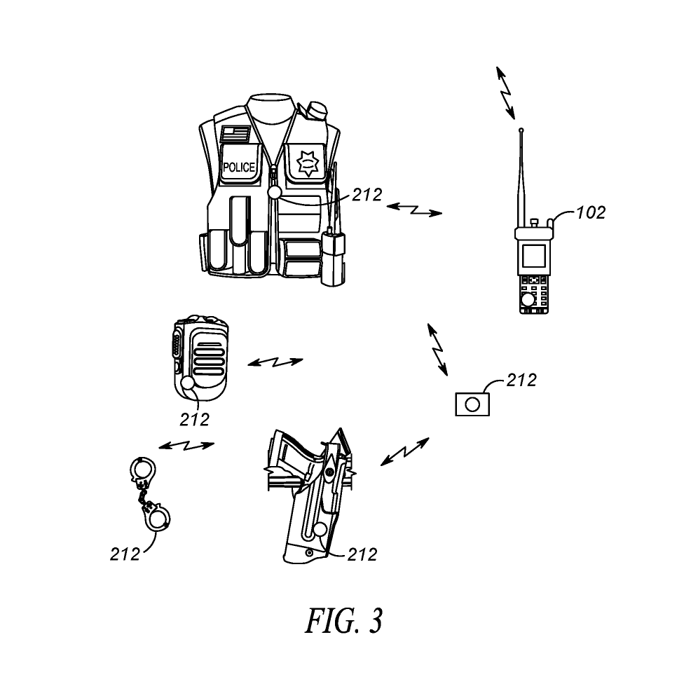

FIG. 3 depicts another view of a personal-area network 240 of FIG. 2. Personal-area network comprises a very local-area network that has a range of, for example 10 feet. As shown in FIG. 3, various devices 212 are that attach to clothing utilized by a public-safety officer. In this particular example, a bio-sensor is located within a police vest, a voice detector is located within a police microphone, smart handcuffs 212 are usually located within a handcuff pouch (not shown), a gun-draw sensor is located within a holster, and a camera 212 is provided.

Devices 212 and hub 102 form a PAN 240. PAN 240 preferably comprises a Bluetooth PAN. Devices 212 and hub 102 are considered Bluetooth devices in that they operate using a Bluetooth, a short range wireless communications technology at the 2.4 GHz band, commercially available from the “Bluetooth special interest group”. Devices 212 and hub 102 are connected via Bluetooth technology in an ad hoc fashion forming a PAN. Hub 102 serves as a master device while devices 212 serve as slave devices.

Hub 102 provides information to the officer, and/or forwards local status alert messages describing each sensor state/trigger/status over a wide-area network (e.g., network 204 or network 206) to computer 214. In alternate embodiments of the present invention, hub 102 may forward the local status alerts/updates for each sensor to mobile and non-mobile peers (shift supervisor, peers in the field, etc.), or to the public via social media. Thus, hub 102 receives sensor information via a first network (e.g., Bluetooth PAN network), and forwards the information to computer 214 via a second network (e.g., wide area network (WAN) such as network 204 or network 206).

As described above, with body-worn cameras becoming ubiquitous, public-safety officers sharing video is becoming more-and-more common. For example, dispatch center may have multiple video streams from multiple officers streaming simultaneously. When viewing multiple streamed videos simultaneously (for example on multiple screens at a dispatch center), dispatch operators often mute the audio on the multiple videos to prevent confusion. Muting of the videos often leads to critical content being missed.

In order to address the above-mentioned issue, during operation dispatch center 214 will have knowledge of a state of devices used to form an officer's personal-area network (PAN) 240. Audio streamed from the officer may be muted or unmuted based on a device state for any device within the PAN. More particularly, dispatch center 214 will map an officer sensor state to a mute/unmute state for video being streamed by the officer.

The mapping process preferably comprises an operation that associates each element of a given set (the domain) with one or more elements of a second set (the range). The PAN sensor state for officer devices 214 comprises the domain, while the mute/unmute state for video streamed by the officer comprise the range. The mapping may be explicit based on predefined rules, or the mapping may be trained via neural network modeling. This is illustrated in Table 1 below.

TABLE 1
Mapping of Sensor State to Mute/Unmute State

| | Mute State of video |
|---|---|
| Sensor State for officer | streamed by officer |
| Handcuff sensor indicates deployed handcuffs | Unmute |
| Handcuff sensor indicates un-deployed handcuffs | Mute |
| Gun-draw sensor indicates gun drawn | Unmute |
| Gun-draw sensor indicates gun not drawn | Mute |
| Heartrate sensor indicates high heart rate | Unmute |
| (>100 BPM) | |
| Heartrate sensor indicates low heart rate | Mute |
| (<100 BMP) | |

It should be noted that a combination of sensor data may be used to determine when to mute and/or unmute audio. For example, location data may be used along with a gun-draw sensor, so that video is not unmuted when the officer is at home, or in the police station. In this case, video will not be unmuted if a gun is drawn at certain locations (e.g., gun range). It should also be noted that audio from more than one video may be unmuted, if officer's streaming the video both experience triggers to unmute. Finally, data from other sensor networks (e.g., a vehicle-area network (VAN)) may be used to determine when to unmute audio. For example, if an police vehicle is traveling at a high rate of speed, audio may be unmuted.

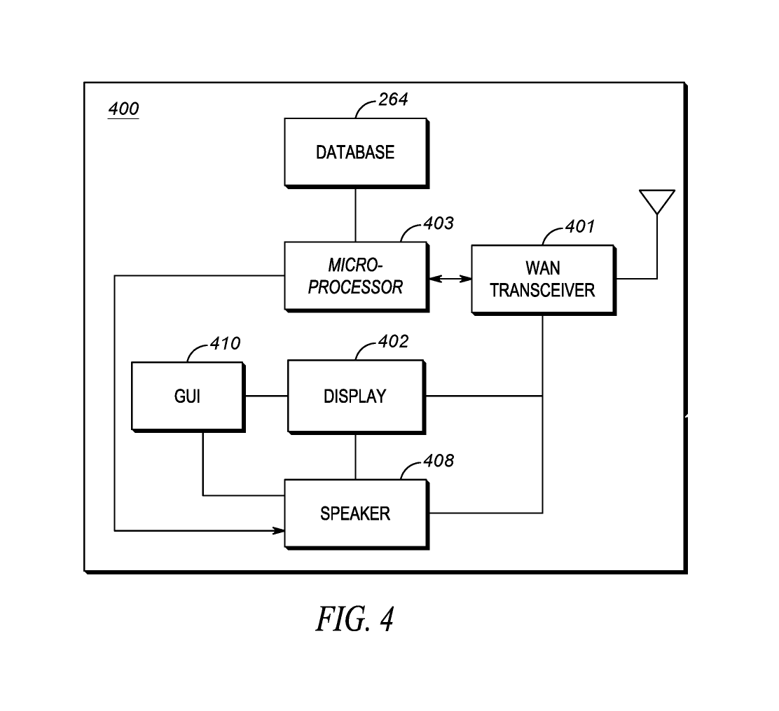

With the above in mind, FIG. 4 sets forth a schematic diagram that illustrates a device 400 muting and/or unmuting video streamed by the officer. In an embodiment, the device is embodied within computer 214 (dispatch center 214), however in alternate embodiments the device may be embodied within the public-safety core network 204, or more computing devices in a cloud compute cluster (not shown), or some other communication device (for example a radio operated by an officer in the field), and/or may be a distributed communication device across two or more entities. Finally, device 400 may be located in any portable device carried by a public-safety officer.

FIG. 4 shows those components (not all necessary) for device 400 to determine sensor state, and mute/unmute speaker 408 accordingly. As shown, device 400 may include a wide-area-network (WAN) transceiver 401 (e.g., a transceiver that utilizes a public-safety communication-system protocol and/or a high-speed data network protocol), display 402, logic circuitry 403, database 264, and speaker 408. In other implementations, device 400 may include more, fewer, or different components. Regardless, all components are connected via common data busses as known in the art.

WAN transceiver 401 may comprise well known long-range transceivers that utilize any number of network system protocols. (As one of ordinary skill in the art will recognize, a transceiver comprises both a transmitter and a receiver for transmitting and receiving data). For example, WAN transceiver 401 may be configured to utilize a next-generation cellular communications protocol operated by a cellular service provider, or any public-safety protocol such as an APCO 25 network or the FirstNet broadband network. WAN transceiver 401 receives sensor data from all PANs 240. It should be noted that WAN transceiver 401 is shown as part of device 400, however, WAN transceiver 401 may be located in RAN 202 (e.g., a base station of RAN 202), with a direct link to device 400.

Display 402 comprises any combination of a touch screen, a computer screen, or any interface capable of displaying video streamed from an officer. It should be noted that for ease of illustration, only a single display is shown in FIG. 4, however in alternate embodiments of the present invention, multiple displays may be present, each streaming a different video from a different officer.

Speaker 408 is shown coupled to display 402, and is used to provide an audible output for associated video on display 402. Speaker 408 can be muted or unmuted, or operated at one of many volume levels. Only one speaker 408 is shown in FIG. 4, however it should be noted that many speakers may be present.

GUI 410 comprises provides a man/machine interface for receiving an input from a user and controlling display 402 and speaker 408. For example, GUI 410 may provide a way of manually muting or un-muting speaker 408, displaying sensor status, controlling a video source shown on display 402, . . . , etc. In order to provide the above features (and additional features), GUI 410 may comprise any combination of a touch screen, a computer screen, a keyboard, or any other interface needed to receive a user input and control display/speaker accordingly.

Logic circuitry 403 comprises a digital signal processor (DSP), general purpose microprocessor, a programmable logic device, or application specific integrated circuit (ASIC) and is configured mute and/or unmute speaker 408 as described above in an automated (e.g., without further user input) or semi-automated (e.g., with some further user input) fashion. More particularly, logic circuitry 403 receives sensor state information from each officer's PAN sensors 212. This information is stored in database 264. Logic circuitry will map the sensor state for an officer to a mute/unmute state for video being streamed by the officer. Speaker 408 will be controlled accordingly. It should be noted that any adjustment to speaker 408 may be overridden by an input from GUI 410 so that a user can mute or unmute speaker 410 as they desire.

Database 264 is provided. Database 264 comprises standard memory (such as RAM, ROM, . . . , etc) and serves to store user identifications along with associated hubs 102, their PAN devices 212, and device status/sensor states (the state of each PAN device). As an example, PAN state information may comprise a battery level, ammunition level, RF signal strength, inventory of emergency aid such as adrenaline shots, gauze, a gun-draw state, . . . , etc. Additionally, database 264 may also comprise mappings from sensor state to mute/unmute state as shown in Table 1.

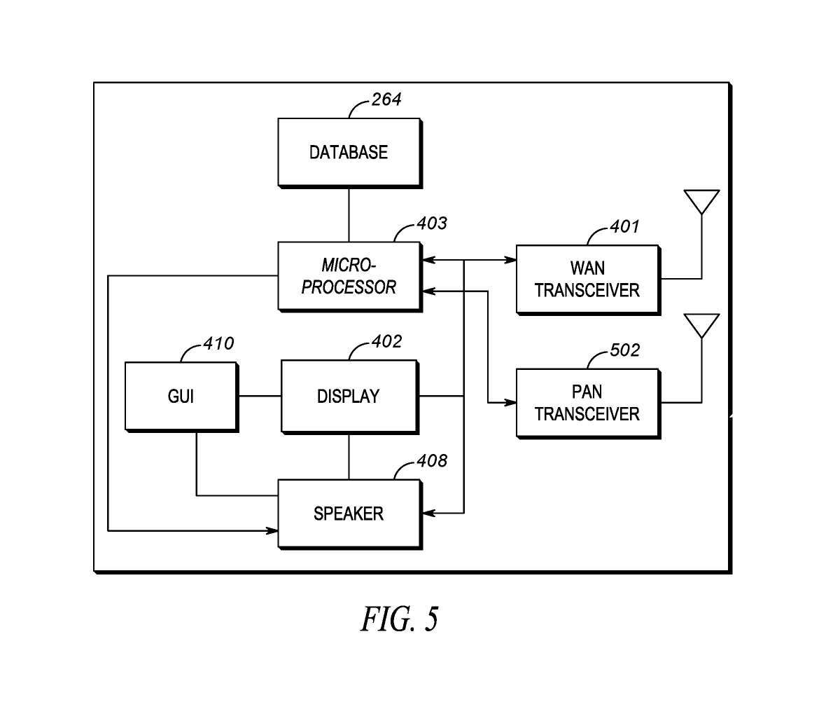

FIG. 5 is a block diagram of hub 102. As shown, hub 102 includes those elements found in FIG. 4, with the addition of PAN transceiver 502. PAN transceiver 502 may be well known short-range (e.g., 30 feet of range) transceivers that utilize any number of network system protocols. For example, PAN transceiver 502 may be configured to utilize Bluetooth communication system protocol for a body-area network, or a private 802.11 network. PAN transceiver 502 receives sensor state information and provides the state information to logic circuitry 403, which forwards the information via WAN transceiver 401 to dispatch center 214. Sensor information is stored in database 264. Logic circuitry 403 will mute/unmute speaker 408 as described above.

Regardless of whether or the above-described muting functionality is located within dispatch center 214, or whether the functionality is located within hub 102, muting and unmuting of speaker 408 will occur based on state information of sensors 212. Some examples follow:

A dispatch operator currently has multiple video streams being displayed on multiple displays 402 with corresponding audio output on several speakers 408, several of which may be displayed on a single display 402. All audio streams are muted. Officer Dave, who is streaming video which is muted draws his weapon. This will cause logic circuitry 403 to unmute the audio stream from Officer Dave.

A dispatch operator currently has multiple video streams being displayed on multiple displays 402, several of which may be displayed on a single display 402. Officer Smith is streaming video. Audio from Officer Smith's stream is not muted. All other audio streams are muted. Officer Dave, who is also streaming video (audio of which is muted) draws his weapon. This will cause logic circuitry 403 to unmute the audio from the video stream from Officer Dave and mute the audio from the video stream of Officer Smith.

With the above in mind, the apparatuses shown in FIG. 4 and FIG. 5 comprise at least a wide-area network (WAN) transceiver configured to receive state information for devices and sensors that form a personal-area network (PAN) and configured to receive streaming video and audio from a camera. A speaker is provided configured to be muted and unmuted and also configured to output audio received from the camera. Finally, logic circuitry is provided configured to map the state information for the devices and sensors that form the PAN to a mute/unmute state for the speaker and output a control signal to mute or unmute the speaker based on the state information for the devices and sensors that form the PAN.

It should be noted that the camera can be part of the PAN, or may not be part of the PAN. Additionally, a database may be provided, and configured to store mappings of sensor states to mute/unmute states, and wherein the logic circuitry accesses the database to determine the mute/unmute state for the speaker. As described above, the devices and sensors that form a PAN comprise body-worn devices and sensors worn by a public-safety officer.

It should also be noted that the PAN and the camera are remote from the logic circuitry, speaker, and WAN transceiver. In particular, it is envisioned that the camera is streaming from a first officer and being viewed by a second officer, remote from the first officer (e.g., blocks or miles apart). The logic circuitry, speaker, and WAN transceiver (located in the vicinity of the second officer) are therefore remote from the camera (located in the vicinity of the first officer).

Finally, a display is provided and configured to output the video received from the camera.

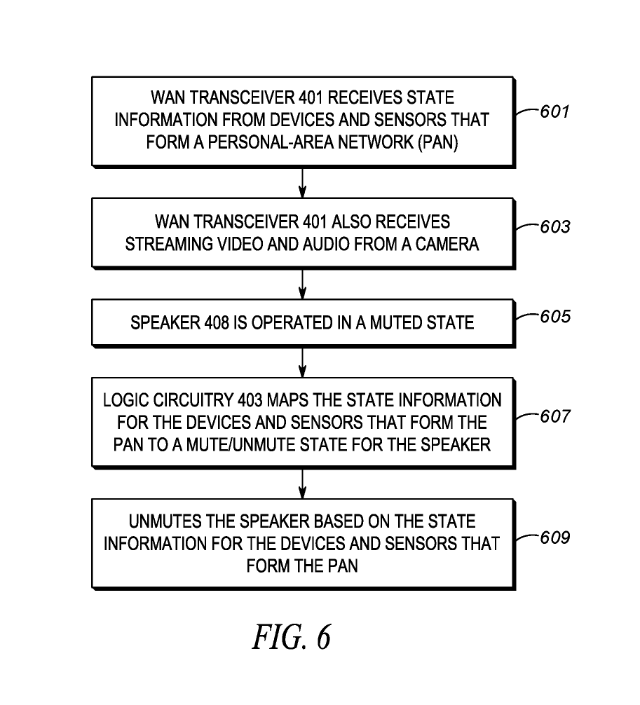

FIG. 6 is a flow chart showing operation of dispatch center or hub muting video as described above. The logic flow begins at step 601 where WAN transceiver 401 receives state information from devices and sensors that form a personal-area network (PAN). WAN transceiver 401 also receives streaming video and audio from a camera (step 603). At step 605 speaker 408 is operated in a muted state. Logic circuitry 403 maps the state information for the devices and sensors that form the PAN to a mute/unmute state for the speaker (607) and unmutes the speaker based on the state information for the devices and sensors that form the PAN (step 609).

As discussed above, the camera may be part of the PAN. Additionally, the devices and sensors that form a PAN comprise body-worn devices and sensors worn by a public-safety officer. Also, it is envisioned that the PAN and the camera are remote from the speaker. Finally, a display may be provided outputting the video received from the camera.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. (canceled)

2. (canceled)

3. (canceled)

4. (canceled)

5. (canceled)

6. (canceled)

7. A method comprising the steps of:
receiving state information at a dispatch center from a gun-draw sensor worn by an officer, the gun-draw sensor being part of a personal-area network (PAN), the officer being remote from the dispatch center;
receiving streaming video and audio at the dispatch center from a camera;
operating a speaker at the dispatch center in a muted state;
mapping the state information for the gun-draw sensor worn by the officer to a mute/unmute state for the speaker at the dispatch center; and
unmuting the speaker at the dispatch center based on the state information for the gun-draw sensor worn by the officer.

8. The method of claim 7 wherein the camera is not part of the PAN.

9. (canceled)

10. The method of claim 7 wherein the PAN and the camera are remote from the speaker.

11. The method of claim 7 further comprising the step of:
outputting the video received from the camera.

12. An method comprising the steps of:
receiving state information at a dispatch center from a gun-draw sensor that is part of a personal-area network (PAN);
receiving streaming video and audio at the dispatch center from a remote body-worn camera that is part of the PAN;
operating a speaker at the dispatch center in a muted state;
mapping, at the dispatch center, the state information for the gun-draw sensor to a mute/unmute state for the speaker at the dispatch center; and
unmuting the speaker at the dispatch center based on the state information for the gun-draw sensor.

13. The method of claim 12 further comprising the steps of:
receiving state information from devices and sensors that form a vehicle-area network (VAN); and
wherein the step of unmuting is additionally based on the state information from the devices and sensors that for the VAN.
